(19) United States
(12) Patent Application Publication
(10) Pub. No.: US 2007/0073751 A1
(43) Pub. Date: Mar. 29, 2007

(54) User interfaces and related methods, systems, and computer program products for automatically associating data with a resource as metadata

(76) Inventors: Robert P. Morris, Raleigh, NC (US); Jared S. Fry, Boston, MA (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/238,708

(22) Filed: Sep. 29, 2005

(51) Int. Cl. G06F 7/00

(52) U.S. Cl. 707/101

(57) ABSTRACT

User interfaces and related methods, systems, and computer program products for automatically associating data with a resource as metadata are disclosed. According to one method, a visual representation of data to be associated with a resource as metadata is displayed. A visual representation of a resource is displayed. User input is monitored for the presence or occurrence of the association action for associating the resource representation with the data representation. In response to detecting the association action, the data is automatically associated with the resource as metadata. The metadata is independent of an association between the resource and a file system for storing the resource.

### RELATED APPLICATIONS

This application is related to a commonly-assigned U.S. patent application entitled, “Methods, Systems, and Computer Program Products for Automatically Associating Data with a Resource as Metadata Based on a Characteristic of the Resource” (Ser. No. not yet assigned) and a commonly-assigned, co-pending U.S. patent application entitled, “Methods, Systems, and Computer Program Products for Resource-to-Resource Metadata Association” (Ser. No. not yet assigned), both filed on even date herewith, the disclosure of each of which is incorporated herein by reference in its entirety.

### TECHNICAL FIELD

The subject matter described herein relates to associating data with a resource as metadata. More particularly, the subject matter described herein relates to user interfaces and related methods, systems, and computer program products for automatically associating data with a resource as metadata.

### BACKGROUND ART

In computer file systems, files are used to store data created by users, software applications, and devices. In addition to user-created content, a computer file may be associated with descriptive information regarding the contents or other aspects of the file. This descriptive information is referred to as metadata. In some instances, metadata is stored in the file. In other instances, metadata is stored outside of the file but is linked to the file.

Some application programs allow users to manually create and associate metadata with a file. For example, digital image organization programs sold with digital cameras may allow a user to manually enter captions to be stored and/or displayed with an image. While such manual metadata creation tools are useful, they require unnecessary time and labor on the part of the end user, because the end user is required to manually input the metadata for each resource.

Some current computer operating systems include limited functionality for automatically associating file system information with files. For example, the Windows® 2000 and Windows® XP operating systems automatically associate a file's location in a file directory tree with the file in response to the file being stored in a file folder that is part of the directory tree. When a user creates a file folder, the user can save a file in the file folder or move the file into the file folder using a graphical method. Once the file is stored in the file folder, the properties of the file are updated to include the file system directory path that corresponds to the file folder. However, the Windows® 2000 and Windows® XP operating systems do not allow a user to define metadata or a visual representation of metadata separately from the underlying file system. As described above, the only automatic metadata association performed by the Windows® 2000 and Windows® XP operating systems is the association of a file folder location with a file.

Newer operating systems include file systems that are more database-oriented than previous operating systems. For example, the Longhorn operating system expected to be released by Microsoft in 2006 includes an unstructured file system and a structured file system. The unstructured file system is the same NTFS file system included in Windows® 2000 and Windows® XP. The structured file system is a database-oriented file system in which file properties are stored and organized as structured database objects. When an application modifies unstructured properties of a file, structured database objects corresponding to the unstructured properties are updated. The process of updating the structured database objects is referred to as promotion. However, the promotion process only maps existing unstructured properties of the file to structured objects maintained by the structured file system. There is no ability in the promotion process to automatically associate data with a resource as metadata that is independent of an association between the resource and a file system for storing the resource.

Still other operating systems, such as Linux® and OS-x® include similar limitations to the above-described operating systems. That is, these operating systems likewise lack the capability to automatically associate data with a resource as metadata where the metadata is independent of an association between the resource and a file system for storing the resource.

In light of these difficulties associated with manual metadata association methods and current operating systems, there exists a need for improved user interfaces and related methods, systems, and computer program products for automatically associating data with a resource as metadata.

### SUMMARY

According to one aspect, the subject matter described herein includes a method for automatically associating data with a resource as metadata. The method includes displaying a visual representation of data to be associated with a resource as metadata. A visual representation of the resource is also displayed. User input is monitored for an occurrence of the association action by which the user can associate the resource representation with the data representation. In response to detecting the association action, data is automatically associated with resource as metadata. The metadata is independent of an association between the resource and a file system for storing the resource.

The subject matter described herein can be implemented using a computer program product comprising computer-executable instructions embodied in a computer-readable medium. Exemplary computer-readable media suitable for implementing the subject matter described herein include chip memory devices, disk memory devices, programmable logic devices, application specific integrated circuits, and downloadable electrical signals. In addition, a computer-readable medium that implements the subject matter described herein may be located on a single device or computing platform or may be distributed across multiple computing devices or computing platforms.

### BRIEF DESCRIPTION OF THE DRAWINGS

Preferred embodiments of the subject matter described herein will now be explained with reference to the accompanying drawings of which:

FIG. 1 is a block diagram of an exemplary system for automatically associating data with a resource as metadata using a user interface according to an embodiment of the subject matter described herein;

FIG. 2 is a block diagram illustrating exemplary components of a metadata association system according to an embodiment of the subject matter described herein;

FIG. 3 is a flow chart illustrating an exemplary process for automatically associating data with a resource as metadata according to an embodiment of the subject matter described herein;

FIG. 4 is a block diagram illustrating an exemplary desktop or application pane that may be used by a metadata association system in automatically associating data with a resource as metadata according to an embodiment of the subject matter described herein;

FIG. 5 is a block diagram illustrating an exemplary desktop or application pane that may be used by a metadata association system in automatically associating data with a resource as metadata according to an embodiment of the subject matter described herein;

FIG. 6 is a block diagram illustrating an exemplary desktop application pane that may be used by a metadata association system in automatically associating data with a resource as metadata according to an embodiment of the subject matter described herein;

FIG. 7 is a block diagram of an exemplary desktop or application pane that may be used by a metadata association system in automatically associating data with a resource as metadata according to an embodiment of the subject matter described herein;

FIG. 8 is a block diagram illustrating resources joined by relational connectors and related metadata association operations that may be implemented by a metadata association system according to an embodiment of the subject matter described herein;

FIG. 9 is a block diagram illustrating an exemplary desktop or application pane that may be used by a metadata association system in automatically associating data with a resource as metadata according to an embodiment of the subject matter described herein; and

FIG. 10 is a flow chart illustrating an exemplary process for automatically associating data with resource as metadata using a metadata mixer according to an embodiment of the subject matter described herein.

### DETAILED DESCRIPTION

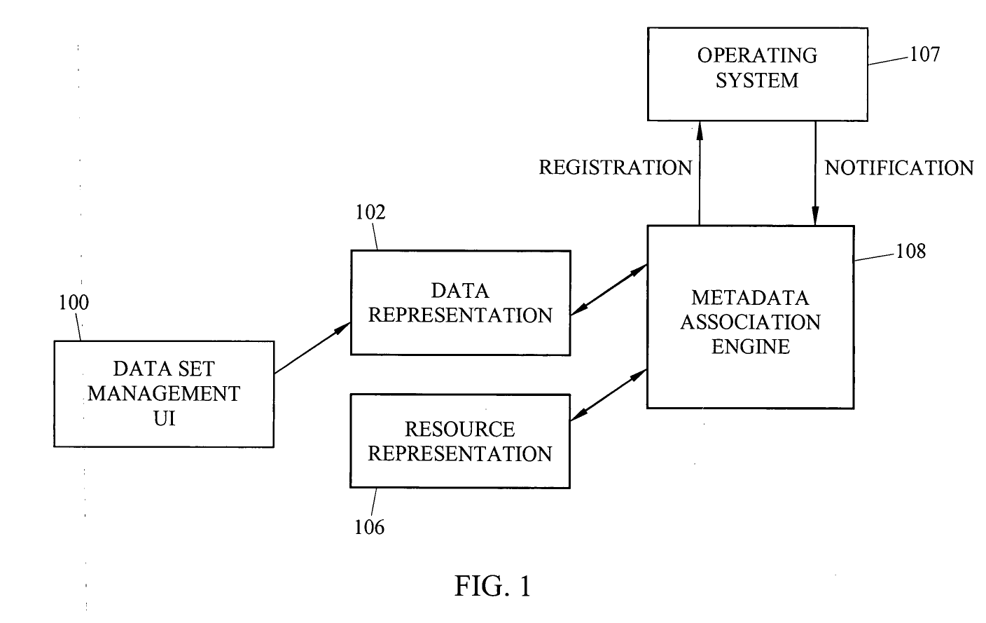

According to one aspect, the subject matter described herein includes a system for automatically associating data with a resource as metadata. FIG. 1 is a block diagram illustrating such a system. Referring to FIG. 1, a data set management user interface 100 allows a user to define data to be associated with resources as metadata and to create a visual representation 102 of the data. Data set management user interface 100 may also allow a user to define rules for selecting data to be associated with a resource as metadata based on a characteristic of the resource. An exemplary interface for defining rules that associate data with resources as metadata is described in the above-referenced commonly assigned U.S. patent application.

Data representation 102 may be any visual representation of the data to be associated with the resource as metadata. For example, data representation 102 may be a graphical and/or textual representation of the data. Data representation 102 may be created by the user and/or data set management user interface 100, rather than automatically by the underlying file system. For example, data representation 102 may be a visual representation of a new file type referred to herein as a “.met” file. That is, the .met extension may uniquely identify the met file type. A .met file may include a set of data items to be associated with a resource as metadata. A user may define a .met file using data set management user interface 100. The met file may include data that is independent from the data that associates the .met file with its location in the file system. The .met file may be a set of keyword-value pairs, a resource description framework (RDF) (an XML syntax for metadata) or other XML schema file, or any data file with a structured format that identifies metadata fields or structures, and the field values. A .met file may be assigned a mime-type, such as text/rdf in the case of rdf files or text/keyword in the case of keyword-value pair files.

In FIG. 1, the system also includes means for displaying a visual representation of data to be associated with the resource as metadata and means for displaying a visual representation of a resource. For example, operating system 107 may control display of data representation 102 and resource representation 106. Resource representation 106 may be any combination of graphics and/or text that represents a system resource. Exemplary system resources that may be represented include files, file folders, applications, database objects, etc.

The system illustrated in FIG. 1 also includes means for monitoring user input for the occurrence of a predefined association action for associating the data representation with the resource representation. For example, metadata association engine 108 may register with operating system 107 as the process to be invoked when user input associating data representation 102 with resource representation 106 occurs. Operating system 107 may monitor user input for association actions, such as drag and drop, drag and hover, or other input actions by which a user can associate data representation 102 with resource representation 106. Monitoring user input for the occurrence of an association action may include monitoring a user input stream from a user input device, such as a keyboard, a mouse, a touch screen, or a microphone, comparing input received via the input device with stored definitions of association actions, and determining whether input received from the user matches any stored association-action definitions. Once operating system 107 detects an association action, operating system 107 may send notification to metadata association engine 108. The notification may include identifiers of data representation 102 and resource representation 106.

The system illustrated in FIG. 1 may also include means for, in response to detecting an association action, automatically associating data with the resource as metadata. For example, metadata association engine 108 may automatically associate data represented by data representation 102 with a resource represented by resource representation 106 in response to receiving notification from operating system 107 indicating that an association action has occurred. Associating the data with the resource as metadata may include storing the data in a tagged field within the resource or storing the data separate from the resource and linking the data to the resource.

The data may be user-defined data, application-defined data, or a combination of user-defined and application-defined data that a user desires to associate with a resource as metadata. The data association may also be governed by one or more metadata association rules that select metadata to be associated with resources based on resource characteristics. Once associated with the resource, the data may be intrinsic metadata, which describes the contents of the resource, or extrinsic metadata, which describes the implementation of a resource in an operating environment, such as a file system. For example, intrinsic metadata regarding a document file may include the title of the document. Extrinsic metadata regarding a document file may include the location of the document in a file system. Either or both types of metadata may be defined and associated with a data representation 102 without departing from the scope of the subject matter described herein. Examples of data and metadata association rules suitable for use with embodiments of the subject matter described herein are described in the above-referenced commonly assigned U.S. patent application entitled, “Methods, Systems, and Computer Program Products for Automatically Associating Data with a Resource as Metadata based on a Characteristic of the Resource.”

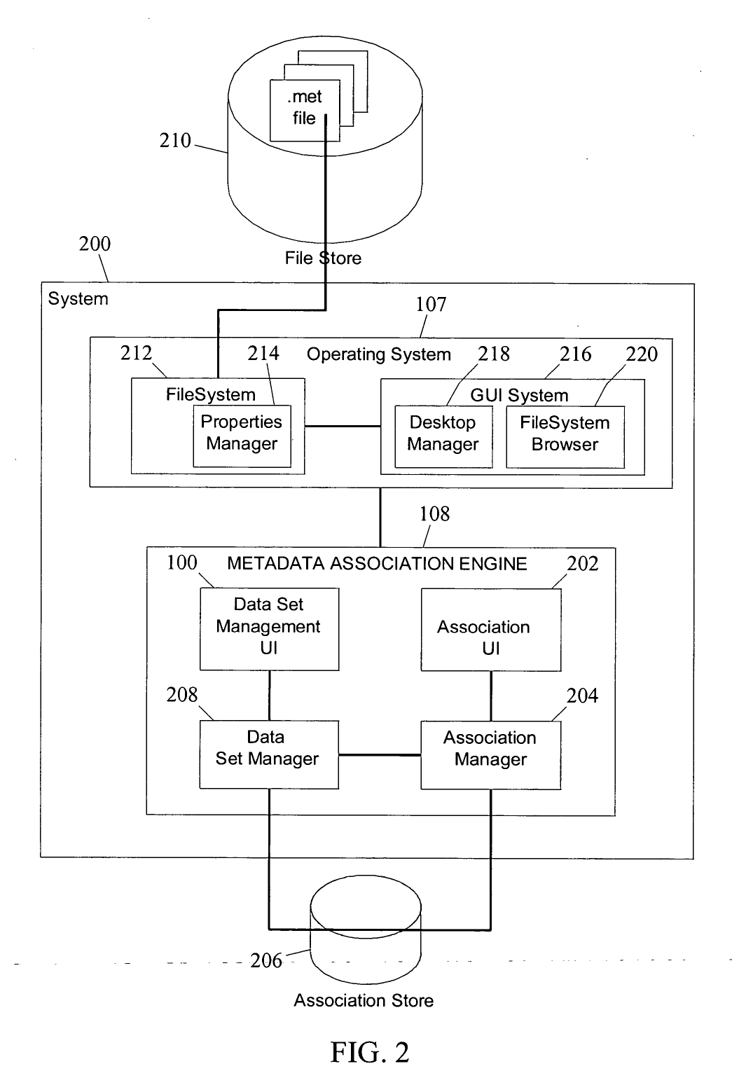

FIG. 2 is a block diagram illustrating an exemplary metadata association system 200 according to an embodiment of the subject matter described herein. Referring to FIG. 2, metadata association system 200 includes data set management user interface 100, operating system 107, and metadata association engine 108 described above with respect to FIG. 1. In addition, metadata association system 200 includes an association user interface 202 for invoking an association manager 204 for browsing associations between system resources and data representations stored in association store 206. Data set management UI 100 may invoke a data set manager 208 for managing data sets and their associated visual representations. Here, managing data sets can include creating, editing, and/or simply displaying the data sets, data set files, data set records, and/or icons associated with any of these.

In the illustrated example, data sets created by a user via data set management UI 100 are stored in file store 210 accessible via file system 212 of operating system 107. File system 212 may include a properties manager 214 that maintains file extensions and their associated file types. Properties manager 214 stores properties for each file, such as its type, size, file attributes, path, etc).

In Windows®, Unix®, and Linux®, file types are associated with icons and/or captions that represent the file when it is displayed to the user via a GUI. .met files likewise can be associated with a unique icon, caption which may include the display of the extension to clearly identify data set files to the user. The visual representation of file types may be managed by properties manager 214 and displayed via GUI system 216 under direction of operating system 107. Users may encounter these representations via a desktop interface controlled by desktop manager 218 or via a file system interface displayed by a file system browser 220. .met files may also appear in the desktop start menu and within applications.

Current operating systems also support associating default actions with events with resource types. For example, the default action when a user clicks on a Microsoft Word® file is to open the file with Word®. When a compatible file is dragged and dropped onto a Microsoft Word® icon, the file is opened in Microsoft Word®. Using the current capabilities of current operating systems, .met files can be associated with default actions. These mapping may also be maintained by properties manager 214. For example, one can right-click on a Windows® or Linux® folder being displayed by file system browser 220, select the “Properties” context menu item in current versions of these operating systems, and update the editable Properties, including the icon to be displayed, context menu actions, and the default action. APIs exist that allow executables to perform equivalent manipulation of file properties. One cannot change the size attribute, for example, from the Properties GUI.

In this embodiment, clicking on a .met visual representation opens the file in a compatible editor (dependent of the format of the file). Dragging and dropping a resource on the visual representation invokes the default metadata association action providing the resource and the .met file identifiers to metadata association engine 108. Metadata association engine 108 may create a record with an identifier (e.g. a URI or URL) of the resource and an identifier of the met file. Metadata association engine 108 may also use current OS APIs to add a menu item to the context menu associated with the resource. The menu item invokes metadata association engine 108 providing the resource id. Metadata association engine 108 looks up the data sets associated with the resource and presents them on the display for example in a pane with a tab for each data set associated with the resource. Other ways to organize the display and other display methods can be used without departing from the scope of the subject matter described herein.

Metadata association engine 108 may also support a context menu item associated with the .met file that invokes metadata association engine 108 providing the id of the .met file as input to metadata association engine 108. Metadata association engine 108 looks up all the resources associated with the .met file and presents them on the display in one of many possible organizations using any number of display widgets supported by the underlying GUI subsystems.

Nested data sets may be supported by allowing the met files to store links to other .met files. When one set is dragged and dropped on another set, the drag and drop association action is invoked as described above. Metadata association engine 108 can detect the type of the dropped resource. If the resource is a met file, metadata association engine 108 adds a link to the file into the met file that was “dropped on”. Nesting can be supported by UI actions other than drag and drop. An API may be provided metadata association engine 108 so that executables can construct nested sets.

As described above, in one exemplary implementation, data sets may be implemented as system files. In an alternate implementation, data sets may be implemented and stored as database records. For example, a set table contains a record for each data set holding an ID and a name for the set. A description or purpose may be supported along with a list of resource types supported by the set. A separate keyword/value table supports the actual data. Each record contains an id, a reference to the data set the keyword is a member of, the keyword name, and the keyword value. Other fields such as a data type field may be supported. In an alternate implementation, the database may be more complex than a simple keyword/value database.

Tools exist currently that map RDF to database tables. Other XML schema to DB mapping tools are also available indicating the format and complexity of the metadata structure is potentially unlimited. Metadata association engine 108 provides a GUI (data set management UI 100) that allows a user to create data sets and add keyword/value records to the set. Similar GUIs may be presented for other data representations. For example, most structured query language (SQL) databases provide a GUI interface that allows users to add/delete/update database records (some more elegant and user friendly than others). In such an implementation, metadata association user interface 108 may create a file for each data set and store the file in a directory tree organized for easy location of the data sets. The file contains the ID of the data set, the file name is the name of the data set. When the user mouses over a visual representation of a data set, the description and/or supported resource types may be displayed. The tree may provide directories based on resource types that the data sets are compatible with. The files may have a unique file extension and mime-type for their type as with .met files. Associations may be stored in a database in a table that maps resource ids to set ids (or metadata association engine 108 could support a resource table and use a link table to associate resources to the data set records in the data set table.).

Nested data sets may be supported in the database by enabling links from a data set record to zero or more other set records. Such links may be implemented using a link table where each record contains the data set ID of the containing data set and the data set ID of the contained data set.

In a database implementation, context menu items may be implemented in a similar manner as with the file system implementation described above. A database implementation has the advantage of enabling easy searches for resources based on queries compatible with the metadata format (e.g. keyword searches for keyword-value data sets).

In both a file-based and database-based data set implementations, metadata association engine 108 may provide an application GUI that allows a user to select a resource or resources by browsing the system, displaying compatible data sets, and allowing the user to select one or more data sets to associate with the selected resource(s).

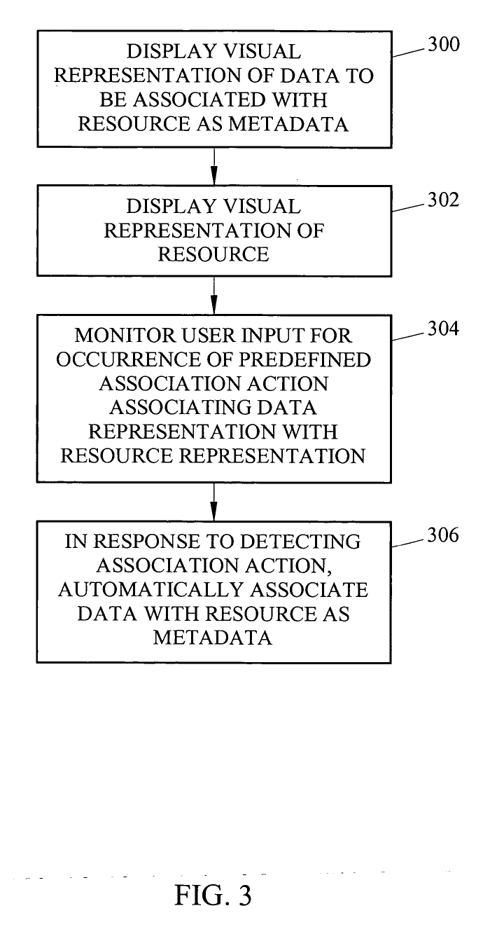

FIG. 3 is a flow chart illustrating an exemplary process for automatically associating data with a resource as metadata according to an embodiment of the subject matter described herein. Referring to FIG. 3, in block 300, a visual representation of data to be associated with a resource as metadata is displayed. As stated above, data set management user interface 100 may allow the user to create the data representation and specify the data set to be associated with the data representation. Once the data representation is created, operating system 107 may display the data representation to the user via a computer display device.

In block-302, a visual representation of the resource is displayed. In block 304, user input is monitored for the occurrence of an association action for associating the data representation with the resource representation. In one example, block 304 may be performed by monitoring input from any suitable user input device or combination of devices, tracking the relative locations of the data representation and the resource representation, and determining whether the location and/or the user input corresponds to a defined association action. In block 306, in response to detecting an association action, data is automatically associated with a resource as metadata.

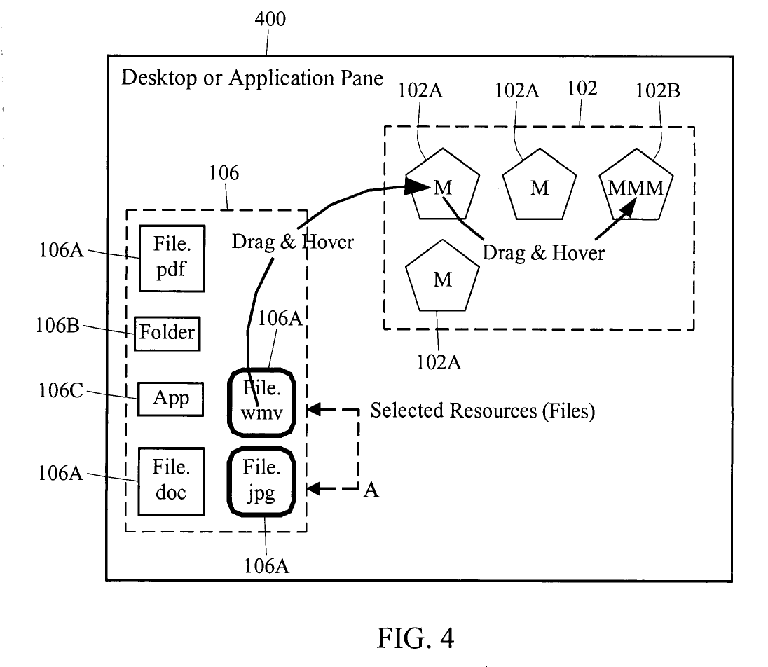

FIG. 4 is a block diagram of a desktop or application pane 400 that may be used by a metadata association system in automatically associating data with a resource as metadata according to an embodiment of the subject matter described herein. Referring to FIG. 4, desktop or application pane 400 includes data representations 102, and resource representations 106. Data representations 102 include graphical representations 102A of single layers of data to be associated with resources as metadata and graphical representation 102B of nested data to be associated with resources as metadata. For example, data representation 102B may represent multiple nested single-layer data representations 102A.

Resource representations 106 may include graphical representations 106A of system files, a graphical representation 106B of a file folder, and a graphical representation 106C of an application. In the illustrated example, operating system 107 monitors user input for the presence or occurrence of a drag and hover action. For example, the user may select resources that the user desires to associate with one or more of data representations 102. The user may drag the representations of the resources and hover the representations of the resources over each data representation 102 corresponding to the data that the user desires to associate with the resources as metadata. In order to prevent false selection, operating system 107 may monitor user input to determine whether a resource representation 106 intersects a data representation 102 by a predetermined amount and/or for a predetermined time period. In response to determining that the intersection has occurred by the predetermined amount and/or for the predetermined time period, an association action may be indicated. It should also be noted that a user may associate resource representations with multiple data representations by hovering the resource representations over each of the desired data representations. In addition, the user may associate a resource representation with a nested data representation by hovering the resource representation over the nested data representation.

The subject matter described herein is not limited to dragging and hovering a resource representation over a data representation to trigger association of data with the resource as metadata. For example, in an alternate implementation, operating system 107 may define an association action as dragging and hovering a data representation over a resource representation. In addition, operating system 107 may define and monitor user input for a disassociation action for disassociating metadata from a resource. The disassociation action may be the reverse of the association action. For example, an association action may be a predetermined mouse gesture, such as a clockwise gesture, when a resource and a data representation are both selected. A disassociation action may be a counterclockwise mouse gesture when a resource representation and a data representation are both selected.

Graphical user input may be combined with keyboard input to implement association and/or disassociation actions. For example, in order to implement an association action, a user may select a resource representation and a data representation using mouse clicks and depress a predetermined key, such as “a.” In order to disassociate metadata from a resource, the user may select the resource representation and a data representation using mouse clicks and depress a predetermined key, such as “d.”

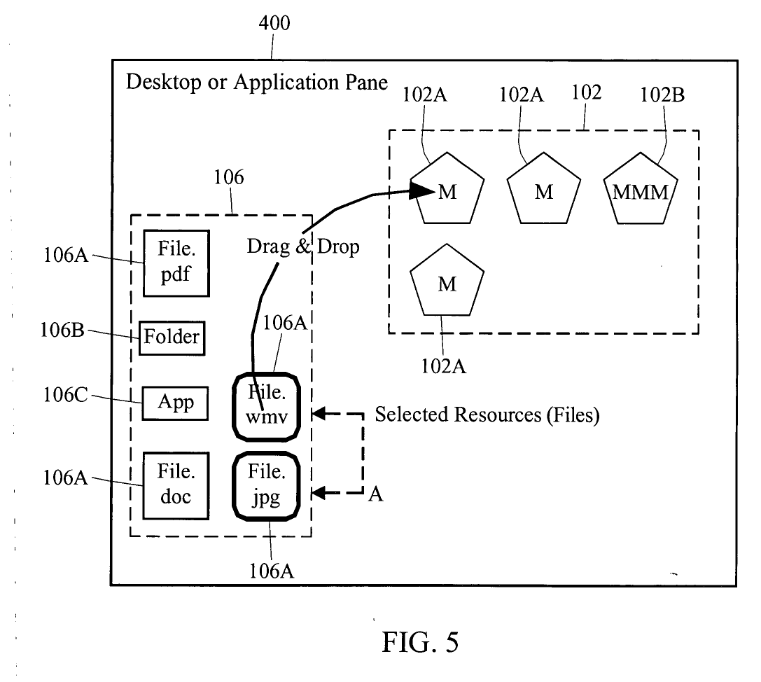

FIG. 5 is a block diagram illustrating an exemplary desktop or application pane that may be used by a metadata association system in automatically associating data with a resource as metadata according to an embodiment of the subject matter described herein. In the illustrated example, a user associates a resource representation 106 with a data representation 102 by selecting the resource representation, dragging the resource representation over the data representation, and dropping the resource representation onto the data representation. As with the drag and hover operation, association may also be triggered by dragging the data representation over the resource representation and dropping the data representation onto the resource representation.

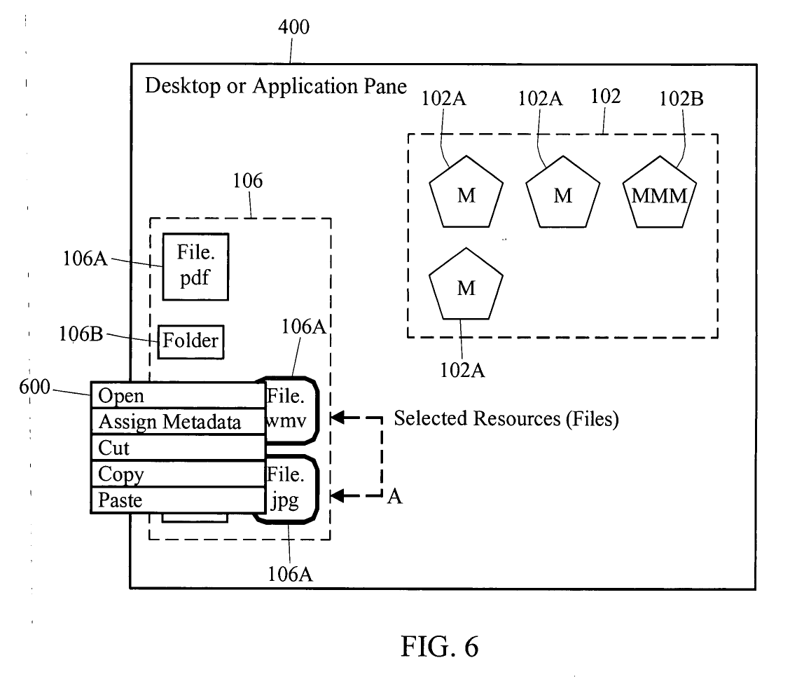

FIG. 6 is a block diagram of an exemplary desktop or application pane that may be used by a metadata association system in automatically associating data with a resource as metadata according to an embodiment of the subject matter described herein. In the example illustrated in FIG. 6, a user associates data with resources as metadata using modal input. Modal input refers to input that is interpreted differently based on the context of an operational mode of an application. For example, a user may select resource representations 106A by left clicking on the representations using an input device, such as a mouse. Once the user right clicks on representations 106A, operating system 107 may enter a mode of operation where a menu is displayed and where mouse clicks are interpreted in the context of the menu. For example, the user may select the “assign metadata” action from menu 600 and then left click on data representations 102 that the user desires to associate with the selected resource. In alternate implementation, rather than requiring the user to left click on selected data representations, when the user selects the “assign metadata” option, a second menu that lists data association representations may appear, and the user may select the data representations that the user desires to associate with the resource representations. Also, the modal operation illustrated in FIG. 6 may be implemented such that the user selects a data representation, an “assign resource” menu option appears, the user selects the “assign resource” option, and the user selects resources that the user desires to associate with the selected data representation. A modal disassociation action may be defined by providing a disassociation option in the menu that appears when a user right clicks on a resource representation.

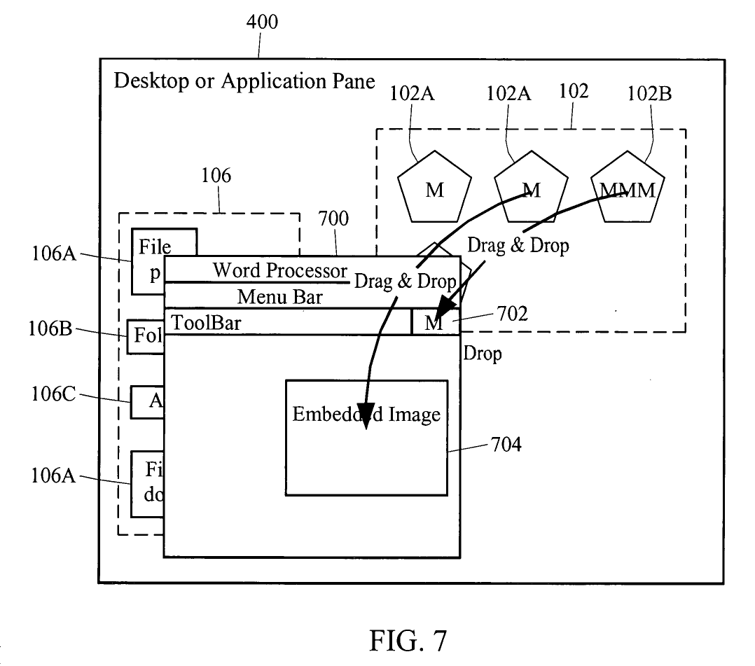

FIG. 7 is a block diagram illustrating an exemplary desktop or application pane that may be used by a metadata association system in automatically associating-data with a resource as metadata-according to an embodiment of the subject matter described herein. In the example illustrated in FIG. 7, a user associates data representations with a resource being displayed by an application. In the illustrated example, application 700 displays a resource, such as a document. Application 700 includes a toolbar with a metadata association icon 702. If the user desires to associate metadata with an entire file, such as a document, displayed by the application, the user can associate one of the data representations 102 with metadata association icon 702. The association can be made using any of the association actions described herein. In addition or in the alternative, if the user desires to associate data with a portion of the document as metadata, the user may associate a portion of the document with a data representation using any of the association actions described herein. In the illustrated example, application 700 displays a file with an embedded image 704. In order to associate data with embedded image 704 as metadata, the user may move the data representation over embedded image 704 and perform the association action, such as dropping the data representation onto embedded image 704 or hovering the data representation over embedded image 704.

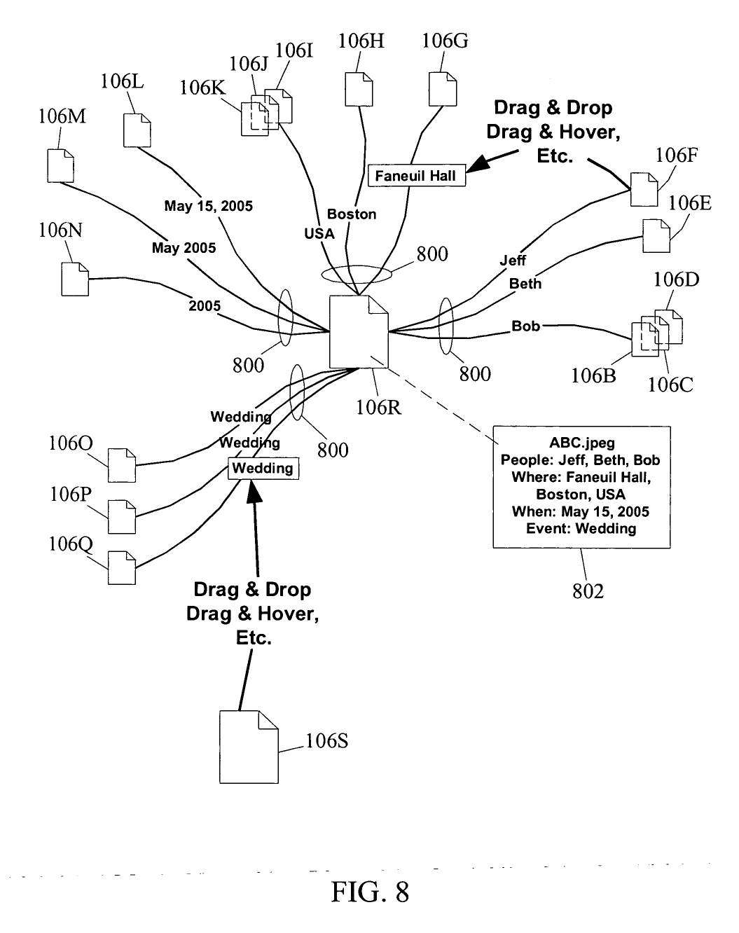

FIG. 8 is a block diagram illustrating an exemplary desktop environment that may be used by a metadata association system in automatically associating data with a resource as metadata according to an embodiment of the subject matter described herein. In the example illustrated in FIG. 8, resource representations 106A-106Q are connected to a central resource representation 106R via relational connectors 800. Each relational connector has associated data that represents metadata of the resources whose representations are connected to the connectors. In this embodiment, each relational connector 800 is a data representation 102. Central representation 106R includes associated metadata 802 that corresponds to the data of the relational connectors. In order to associate data with a resource representation 106S as metadata, the user may move resource representation 106S to the location of one of relational connectors 800 and drop resource representation 106S onto the relational connector or hover resource representation 106S over the relational connector. In response to the association action, data associated with the relational connector will be associated with the resource as metadata. This operation may also be performed for resources that are already connected to one of relational connectors 800. For example, if a user drags and hovers resource representation 106F over the relational connector with data “Faneuil Hall,” the data “Faneuil Hall” may be associated with the resource corresponding to resource representation 106F as metadata.

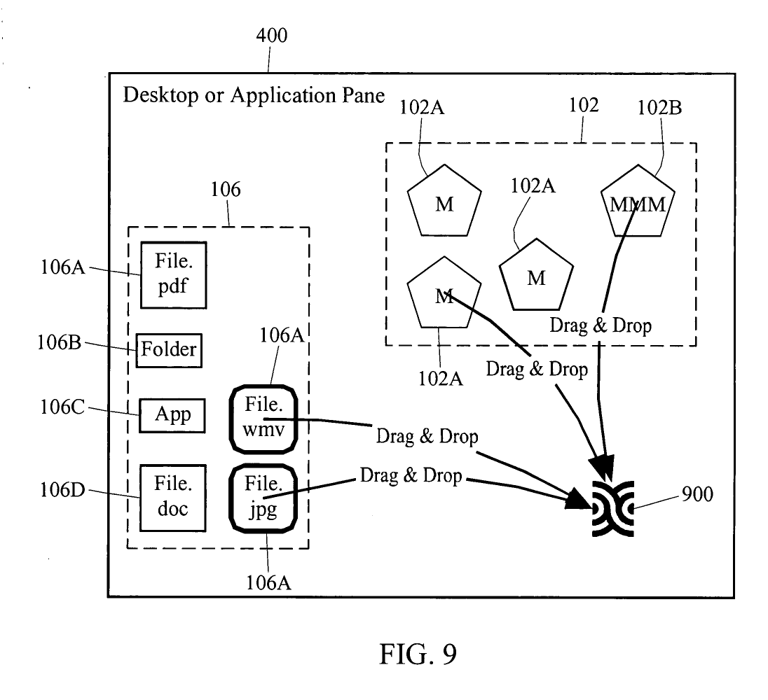

According to another aspect, the subject matter described herein includes a metadata mixer that mixes data to be associated with a resource as metadata. FIG. 9 illustrates an example of a metadata mixer. Referring to FIG. 9, operating system 107 may display application pane 400, which includes a metadata mixer representation 900. When a user associates resource representations 106 and data representations 102 with metadata mixer representation 900, data associated with each data representation may be associated with each resource representation as metadata. The data may also be associated with metadata mixer representation 900 so that the data will be associated as metadata with future resources associated with metadata mixer representation 900. Associations between resources and metadata mixer representation 900 may also be maintained so that as new data is associated with metadata mixer representation 900, the data is automatically associated as metadata with the resources previously associated with the metadata mixer representation 900.

The resource representations and data representations may be associated with metadata mixer representation 900 in any suitable manner, such as drag and drop, drag and hover, etc. In addition, data may be associated with the resources as metadata independently of the order in which resource representations 106 and data representations 102 are associated with metadata mixer representation 900.

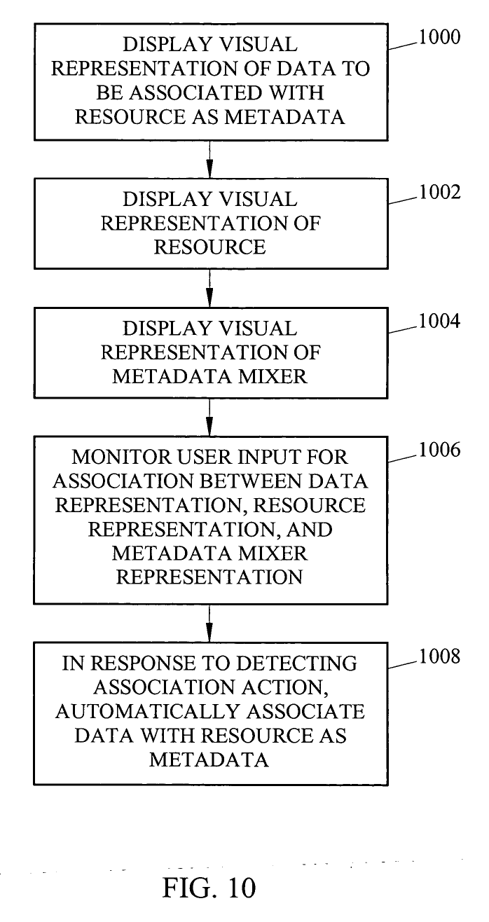

FIG. 10 is a flow chart illustrating an exemplary process for automatically associating data with a resource as metadata using the metadata mixer illustrated in FIG. 10. Referring to FIG. 11, in block 1000, metadata association interface 100 displays a visual representation of data to be associated with a resource as metadata. In block 1002, operating system 107 displays a visual representation of a resource. In block 1004, operating system 107 displays a visual representation of metadata mixer 1000.

In block 1006, operating system 107 monitors user input for an association between the data representation, the resource representation, and the metadata mixer representation. In block 1108, in response to detecting the association, the data corresponding to the data representation is automatically associated with the resource corresponding to the resource representation as metadata. In an alternate implementation, the data association may be delayed until the user performs further action, such as double clicking on the metadata mixer representation.

Metadata mixer representation 900 may include a disassociation mode of operation that automatically disassociates data from resources associated with metadata mixer representation 900 when a data representation is associated with the mixer representation when the disassociation mode is activated. The disassociation mode may be activated using any suitable means, such as right clicking on the mixer and selecting a disassociation mode option from a menu. Alternatively, a reverse mixer representation may be displayed separately form mixer representation 900 where the reverse mixer representation implements the disassociation operation for the metadata mixer representation.

It will be understood that various details of the invention may be changed without departing from the scope of the invention. Furthermore, the foregoing description is for the purpose of illustration only, and not for the purpose of limitation.

What is claimed is:

1. A method for automatically associating data with a resource as metadata, the method comprising:
displaying a visual representation of a resource;
displaying a visual representation of data to be associated with a resource as metadata;
monitoring user input for the occurrence of a predetermined association action for associating the resource representation with the data representation; and
in response to detecting the association action, automatically associating the data with the resource as metadata, wherein the metadata is independent of an association between the resource and a file system for storing the resource.

2. The method of claim 1 wherein displaying a visual representation of data to be associated with a resource as metadata includes displaying a graphical representation of data to be associated with a resource as metadata.

3. The method of claim 1 wherein displaying a visual representation of data to be associated with a resource as metadata includes displaying textual representation of data to be associated with a resource as metadata.

4. The method of claim 1 wherein displaying a visual representation of a resource includes displaying a graphical representation of the resource.

5. The method of claim 1 wherein displaying a visual representation of a resource includes displaying a textual representation of the resource.

6. The method of claim 1 wherein monitoring user input for the occurrence of an association action includes monitoring user input for the occurrence of a drag and hover action by which the user can trigger the association of the data with the resource as metadata by dragging and hovering the resource representation-over the data representation.

7. The method of claim 6 wherein monitoring user input for the occurrence of the drag and hover action includes:
detecting a correspondence between a location of the resource representation and a location of the data representation;
determining whether the correspondence exists for a predetermined time period; and
in response to determining that the correspondence exists for the predetermined time period, indicating the occurrence of the drag and hover action.

8. The method of claim 1 wherein monitoring user input for the occurrence of an association action includes monitoring user input for the occurrence of a drag and hover action by which the user can trigger the association of the data with the resource as metadata by dragging and hovering the data representation over the resource representation.

9. The method of claim 1 wherein displaying a visual representation of data to be associated with a resource as metadata includes displaying a visual representation of nested data to be associated with a resource as metadata and wherein automatically associating the data with the resource as metadata includes automatically associating the nested data with the resource as metadata.

10. The method of claim 1 wherein monitoring user input for the occurrence of an association action includes monitoring user input for the occurrence of a first mouse gesture for associating the data representation with the resource representation wherein the method further comprises monitoring user input for the occurrence of a second mouse gesture for disassociating the data representation from the resource representation.

11. The method of claim 1 wherein monitoring user input for the occurrence of an association action includes monitoring user input for the presence of predetermined input from a keyboard for associating the data representation with the resource representation.

12. The method of claim 1 wherein monitoring user input for the occurrence of an association action includes monitoring user input for the occurrence of a drag and drop action by which a user can drag the data representation over the resource representation and drop the data representation onto the resource representation to trigger the association of the data with the resource as metadata.

13. The method of claim 1 wherein monitoring user input for the occurrence of an association action includes monitoring user input for the occurrence of a drag and drop action by which a user can drag the resource representation over the data representation and drop the resource representation onto the data representation to trigger association of the data with the resource as metadata.

14. The method of claim 1 wherein monitoring user input for the occurrence of an association action includes monitoring user input for the occurrence of modal input from a user input device.

15. The method of claim 1 comprising displaying a metadata association icon on an application toolbar and wherein monitoring user input for the occurrence of an association action includes monitoring user input for the occurrence of a toolbar association action by which a user can trigger the association of the data with the resource by associating the data representation with the toolbar icon.

16. The method of claim 1 wherein displaying a representation of a resource includes displaying an application interface that displays contents of the resource and wherein monitoring user input for the occurrence of the association action includes monitoring user input for an association between the data representation and a portion of the resource displayed by the application interface and wherein automatically associating the data with a resource as metadata includes automatically associating the data with the portion of the resource.

17. The method of claim 1 wherein displaying a visual representation of data to be associated with a resource as metadata includes displaying visual representations of a plurality of resources connected with relational connectors and data associated with each connector wherein monitoring user input for the occurrence of an association action includes monitoring user input for the occurrence of an action by which a user can trigger association of data associated with a connector with a selected resource representation as metadata.

18. The method of claim 1 wherein automatically associating the data with the resource as metadata includes selecting a predetermined portion of the data to be associated with the resource as metadata based on a characteristic of the resource.

19. A method for automatically associating data with a resource as metadata, the method comprising:
displaying a visual representation of a data to be associated with a resource as metadata;
displaying a visual representation of a resource;
displaying a visual representation of a metadata mixer;
monitoring user input for an association between the resource representation, the data representation, and the metadata mixer representation; and
in response to detecting the association, automatically associating the data with a resource as metadata.

20. The method of claim 19 comprising monitoring user input for association between a plurality of different data representations, the resource representation, and the metadata mixer and, in response to detecting the association, automatically associating data represented by each of the plurality of different data representations with the resource as metadata.

21. The method of claim 19 comprising maintaining association between the resource representation and the metadata mixer representation and automatically associating new data with the resource as metadata in response to new data representations being associated with the metadata mixer.

22. The method of claim 19 comprising automatically disassociating the data from the resource in response to the resource representation being disassociated from the metadata mixer association.

23. A system for automatically associating a data with resource as metadata, the system comprising:
a data set management user interface for managing a visual representation of data to be associated with a resource as metadata;
means for monitoring user input for the presence of an association action involving the data representation and a visual representation of a resource and for generating a notification indicative of the association action; and
a metadata association engine for receiving the notification, and, in response to receiving the notification, for automatically associating the data with the resource as metadata, wherein the metadata is independent of an association between the resource and a file system for storing the resource.

24. The system of claim 23 wherein the means for monitoring is adapted to monitor user input for the occurrence of a drag and hover action by which the user can trigger the association of the data with the resource as metadata by dragging and hovering the resource representation over the data representation.

25. The system of claim 24 wherein, in monitoring the user input stream for the occurrence of the drag and hover action, the means for monitoring is adapted to:
detect a correspondence between a location of the resource representation and a location of the data representation;
determine whether the correspondence exists for a predetermined time period; and
in response to determining that the correspondence exists for the predetermined time period, to indicate the occurrence of the drag and hover action.

26. The system of claim 23 wherein the means for monitoring is adapted to monitor the user input for the occurrence of a drag and hover action by which the user can trigger the association of the data with the resource as metadata by dragging and hovering the data representation over the resource representation.

27. The system of claim 23 wherein, in displaying a visual representation of data to be associated with a resource as metadata, the means for monitoring is adapted to display a visual representation of nested data to be associated with a resource as metadata and wherein, in automatically associating the data with the resource as metadata, the metadata association engine is adapted to associate the nested data with the resource as metadata.

28. The system of claim 23 wherein the means for monitoring is adapted to monitor the user input for the occurrence of a first mouse gesture for associating the data representation with the resource representation and for a second mouse gesture for disassociating the data representation from the resource representation.

29. The system of claim 23 wherein the means for monitoring is adapted to monitor the user input for a predetermined keyboard input for associating the data representation with the resource representation.

30. The system of claim 23 wherein the means for monitoring is adapted to monitor the user input for the occurrence of a drag and drop action by which a user can drag the data representation over the resource representation and drop the data representation onto the resource representation to trigger the association of the data with the resource as metadata.

31. The system of claim 23 wherein the means for monitoring is adapted to monitor the user input for the occurrence of a drag and drop action by which a user can drag the resource representation over the data representation and drop the resource representation onto the data representation to trigger association of the data with the resource as metadata.

32. The system of claim 23 wherein the means for monitoring is adapted to operate in a first mode of operation for monitoring input from a user device during which user input received with a user input device is interpreted as the association action and in a second mode of operation in which the user input is not interpreted as the association action.

33. The system of claim 23 wherein the means for monitoring is adapted to display a metadata association icon on an application toolbar and to trigger the association of the data with a resource as metadata in response to receiving user input for associating the icon with the data representation.

34. The system of claim 23 wherein the means for monitoring is adapted to monitor user input for the occurrence of an association action for association between the data representation and a portion of a resource displayed by the application interface and wherein, in response to receiving the notification, the metadata association engine is adapted to associate the data with the portion of the resource as metadata.

35. The system of claim 23 wherein the means for monitoring is adapted to monitor user input for association between data associated with a connector connecting resource representations and a selected resource representation as metadata.

36. The system of claim 23 wherein the metadata association engine is adapted to select data to be associated with the resource as metadata based on a characteristic of the resource.

37. A system for automatically associating data with a resource as metadata, the system comprising:
means for displaying a visual representation of data to be associated with a resource as metadata, for displaying a visual representation of a resource, for displaying a visual representation of a metadata mixer, and for monitoring user input for an association between the resource representation, the data representation, and the metadata mixer representation; and
a metadata association engine for, in response to detection of the association, automatically associating the data with the resource as metadata.

38. The system of claim 37 wherein the means for displaying is adapted to monitor user input for association between a plurality of different data representations, the resource representation, and the metadata mixer and, in response to detection of the association, the metadata association engine is adapted to automatically associate data of each of the plurality of different data representations with the resource as metadata.

39. The system of claim 37 wherein the metadata association engine is adapted to maintain an association between the resource and the metadata mixer association and to automatically associate new data with the resource as metadata in response to new data representations being associated with the metadata mixer representation.

40. The system of claim 37 comprising a reverse metadata mixer operatively associated with the metadata mixer representation for automatically disassociating the data from the resource in response to the data representation being disassociated from the metadata mixer representation.

41. A system for automatically associating data with a resource as metadata, the system comprising:
means for displaying a visual representation of data to be associated with a resource as metadata, wherein the visual representation of data represents data independent of an association between the resource and a file system for storing the resource;
means for displaying a visual representation of a resource;
means for monitoring user input for the occurrence of a predetermined association action for associating the resource representation with the data representation; and
means for, in response to detecting the association action, automatically associating the data with the resource as metadata.

42. A computer program product comprising computer-executable instructions embodied in a computer-readable medium for performing steps comprising:
displaying a visual representation of data to be associated with a resource as metadata, wherein the visual representation of data represents data independent of an association between the resource and a file system for storing the resource;
displaying a visual representation of a resource;
monitoring user input for the occurrence of a predetermined association action for associating the resource representation with the data representation; and
in response to detecting the association action, automatically associating the data with the resource as metadata.
